(19) United States
(12) Patent Application Publication
(10) Pub. No.: US 2012/0313747 A1
(43) Pub. Date: Dec. 13, 2012

(54) METHOD FOR AUTHENTICATING SECURITY MARKERS

(76) Inventors: Thomas D. Pawlik, Rochester, NY (US); Myra T. Olm, Webster, NY (US); Judith A. Bose, Webster, NY (US); Thomas J. Widzinski, Rochester, NY (US)

(21) Appl. No.: 13/156,602

(22) Filed: Jun. 9, 2011

(51) Int. Cl. G05B 19/00

(52) U.S. Cl. 340/5.8

(57) ABSTRACT

A method for authenticating security markers includes preparing a security marker with at least two or more optically active compounds; applying the security marker to an article to be authenticated; illuminating the security marker with radiation; detecting the optical response of the security marker; and wherein the two or more optically active compounds have a complementary response to different wavelengths of the illuminating radiation.

### CROSS REFERENCE TO RELATED APPLICATIONS

Reference is made to commonly-assigned copending U.S. patent application Ser. No. ______ (Attorney Docket No. K000250US01NAB), filed herewith, entitled AUTENTICATION OF A SECURITY MARKER, by Pawlik et al.; and U.S. patent application Ser. No. ______ (Attorney Docket No. K000387US01NAB), filed herewith, entitled AUTENTICATION OF A SECURITY MARKER, by Pawlik et al.; the disclosures of which are incorporated herein.

### FIELD OF THE INVENTION

The present invention relates in general to authenticating objects and in particular to compensating for temperature changes of lasers used in the authentication process.

### BACKGROUND OF THE INVENTION

Many high value products are subject to counterfeiting and there is a need to authenticate objects to differentiate the objects from counterfeits. One method of authenticating objects incorporates an optically active compound in a marker on the object. The marker is illuminated and the luminescence from the optically active compounds is detected. Subject to certain algorithms the marker is either authenticated or rejected.

A suitable illumination source is a semiconductor laser. A problem with the laser as a light source is the wavelength generated by the laser shifts with changes in temperature. Therefore the optical response of the optically active compound may vary with changes in wavelength. This may cause false readouts or failure to authenticate valid objects.

It is possible to stabilize laser temperature using a thermostat. This adds additional components to the system and reduces battery lifetime due to the need for heating or cooling. One could also monitor, but not control, the laser temperature and derive a scaling factor from a look-up table. However, it would be necessary to generate a table for every individual laser, because the wavelength of the laser diode at a nominal temperature is subject to manufacturing tolerances.

### SUMMARY OF THE INVENTION

Briefly, according to one aspect of the present invention a method for authenticating security markers includes preparing a security marker with two or more optically active compounds. The security marker is applied to an article to be authenticated and illuminated with radiation. The optical response of the security marker is detected and the two or more optically active compounds have a complementary response to different wavelengths of the illuminating radiation.

The invention and its objects and advantages will become more apparent in the detailed description of the preferred embodiment presented below.

### BRIEF DESCRIPTION OF THE DRAWINGS

FIG. 1 shows a plan view of a security marker detection system;

FIG. 2 shows a block diagram of a security marker detection system;

FIG. 3 shows a schematic of optoelectronic components of a security marker detection system;

FIG. 4 shows the excitation and emission spectra of two markers; and

FIG. 5 shows the temperature profile of the security marker detection system for several markers and marker mixtures.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

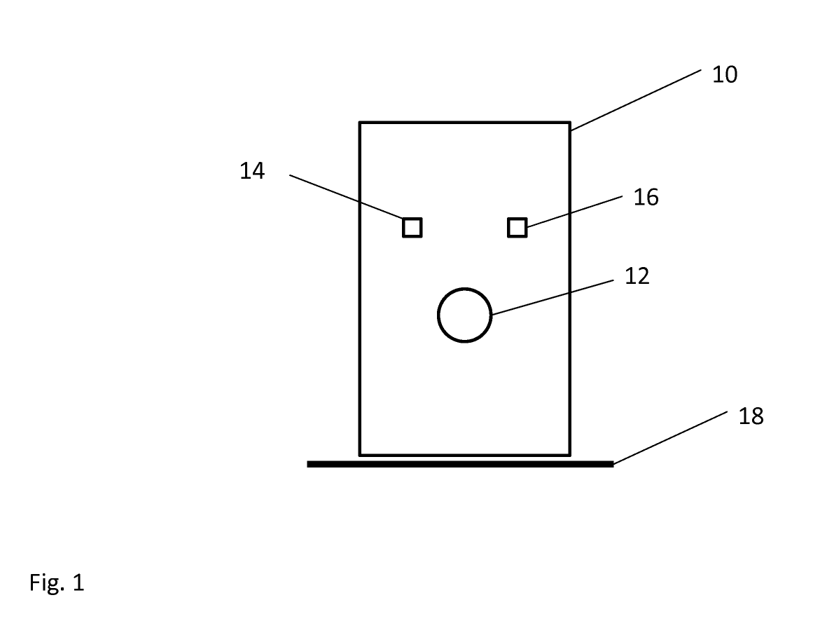

Referring now to FIG. 1 which shows a security marker detection system 10 which can be used to detect emission of security marker materials. FIG. 1 also shows the item to be authenticated 18. Authentication is performed by pressing the test button 12. The result is displayed by either a pass indicator light 14 or a fail indicator light 16.

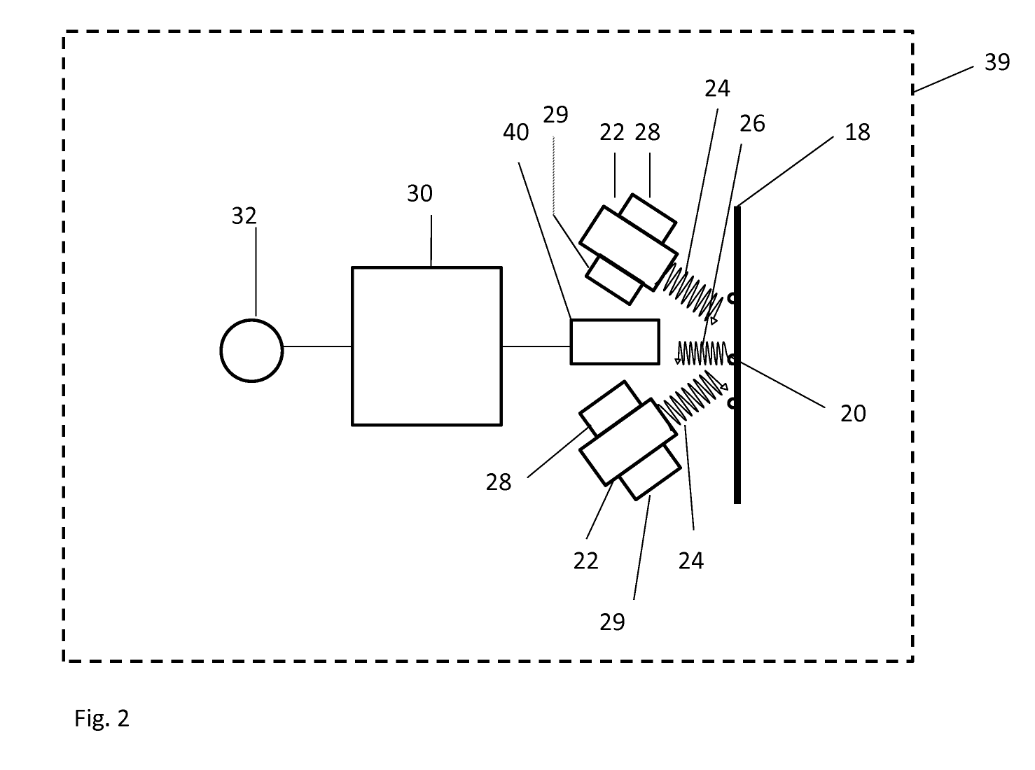

Referring now to FIG. 2 which shows a security marker detection system 39 which can be used to detect emission of security marker materials in a non image-wise fashion. One or more irradiation sources 22 direct electromagnetic radiation towards the item to be authenticated 18. The authentic item contains a random distribution of marker particles 20 either in an ink or in an overcoat varnish. The marker particles emit electromagnetic radiation 26 as a response to the radiation from the irradiation sources 22 which is detected by a photodetector 40. A microprocessor 30 analyzes the photodetector signal and determines a pass or fail indication which is displayed on the authentication indicator 32. Pass or fail indication can, for example, represent authentic and non-authentic, respectively. Optionally, the irradiation sources 22 are thermally coupled to a temperature sensor 28 and heating/cooling element 29, which are also controlled by the microprocessor 30. These are useful for the conduction of experiments to optimize marker formulation.

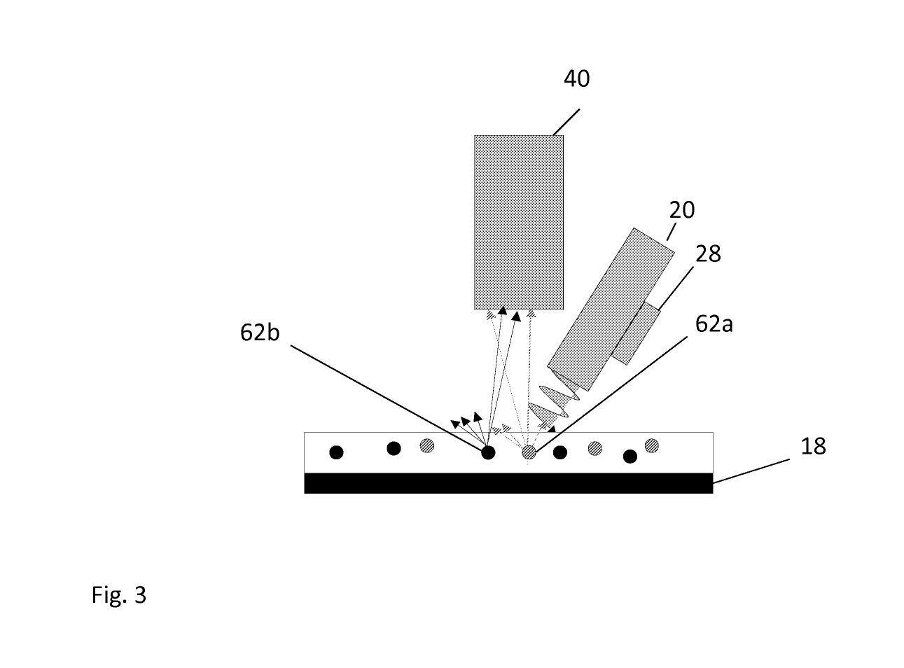

Referring now to FIG. 3 which shows the optoelectronic components of a security marker detection system that illuminate a substrate containing a mixture of markers. The individual markers respond to the illuminating irradiation and emit light that is detected by the photodetector. The intensity of the emitted light from each individual marker depends in the illumination intensity and the overlap between the spectral band of the illuminating radiation and the spectral shape of the excitation band of the marker. If a semiconductor laser is used as an excitation source, the illumination has a narrow bandshape, but the wavelength of illumination varies with the temperature of the laser. The emission wavelength will shift to longer wavelength with increasing temperature and to shorter wavelengths with decreasing temperature. Typical shifts are 0.3 nm/° C. For security markers with a narrow excitation band, the response of the security marker detection system will vary with the temperature of the illumination source. This is an undesirable effect. The invention provides a means to mitigate this temperature variability by using a mixture of markers with different optical excitation spectra. A suitable mixture provides a more continuous response for optical excitation across the normal operational temperatures of the security marker detection system.

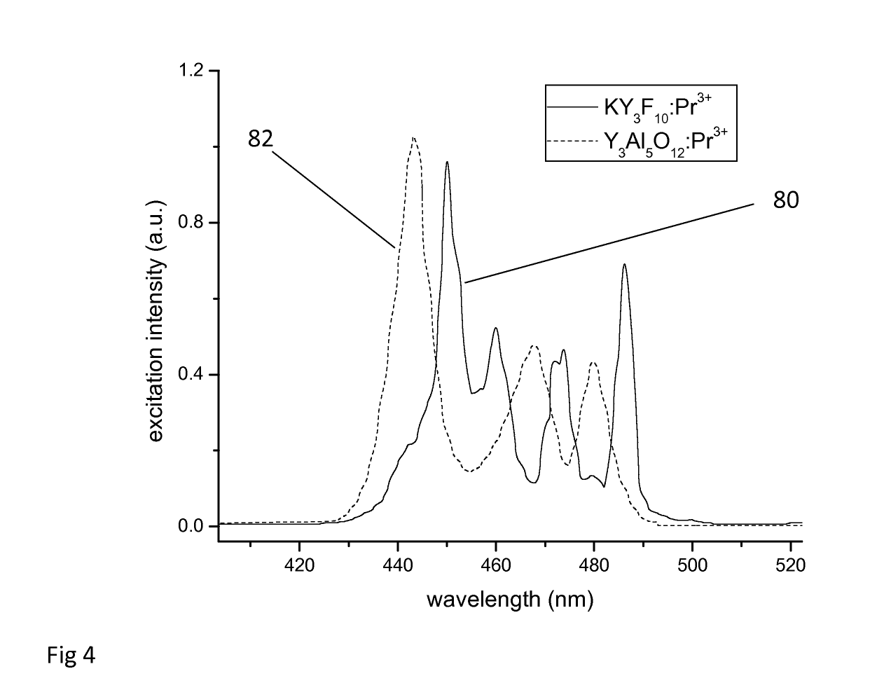

Referring now to FIG. 4 which shows typical excitation spectra of two emissive materials, Y₃Al₅O₁₂:Pr³⁺ 80 and KY₃F₁₀:Pr³⁺, 82. The Pr³⁺ ion is the emissive element in these materials. Because it is embedded in a different host matrix (Y₃Al₅O₁₂ in the first case and KY₃F₁₀ in the second case) the excitation spectra are shifted slightly. For example, the excitation maximum of Y₃Al₅O₁₂:Pr³⁺ is slightly longer in wavelength than 450. The invention provides a means to mitigate this temperature variability of the response by using a mixture of markers with different optical excitation spectra, for example a mixture of Y₃Al₅O₁₂:Pr³⁺ and KY₃F₁₀:Pr³⁺. A semiconductor laser that emits light at a wavelength of 450 nm at room temperature (22° C.) is a suitable excitation source for these markers. Because the excitation bands are partially overlapping but slightly shifted in wavelength, the illumination source can excite the marker mixture over a wider temperature range of the illumination source which provides a more continuous response across the normal operational temperatures of the security marker detection system. Although laser diodes are mentioned in this example, other solid state illumination sources like LEDs experience a similar wavelength variation with temperature.

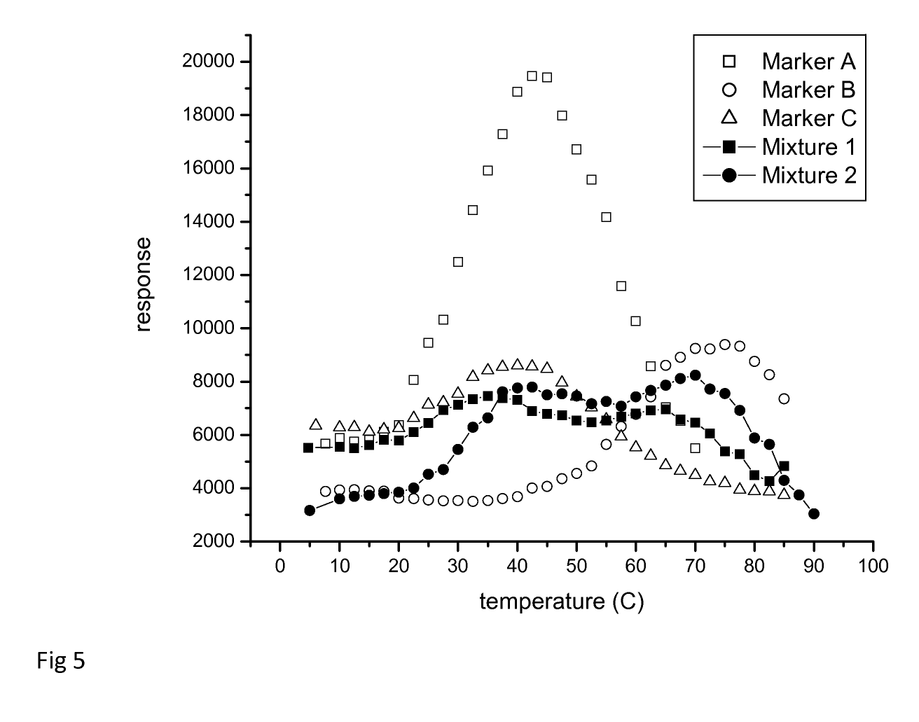

Referring now to FIG. 5 which shows the response of the security marker detection system as a function of the temperature of the illumination source for a selection of markers and mixtures of markers. The open symbols represent the temperature profile of the pure markers A, B and C. The closed symbols represent the response of two mixtures: Mixture 1 is a mixture of markers B and C, Mixture 2 is a mixture of markers A and B. The component ratios were B:C=1:1.65 for Mixture 1 and A:B=1:3.2 for Mixture 2. The temperature profile for the two mixtures clearly shows the improvement in temperature invariability of the mixtures with respect to the pure components.

The invention has been described in detail with particular reference to certain preferred embodiments thereof, but it will be understood that variations and modifications can be effected within the scope of the invention.

### PARTS LIST

10 security marker detection system

12 button to initiate authentication

14 authentication indicator pass

16 authentication indicator fail

18 marked item to be authenticated

20 security marker particle

22 irradiation source

24 exciting electromagnetic radiation

26 emitted electromagnetic radiation

28 temperature sensor

29 heating/cooling element

28 sensor

30 microprocessor and memory

32 authentication indicator

39 authentication device employing non image-wise detection

40 photodetector

62a marker particle 1

62b marker particle 2

80 excitation spectrum of Y₃Al₅O₁₂:Pr³⁺

82 excitation spectrum of KY₃F₁₀:Pr³⁺,

1. A method for authenticating security markers comprising:
preparing a security marker with at least two or more optically active compounds;
applying the security marker to an article to be authenticated;
illuminating the security marker with radiation;
detecting the optical response of the security marker; and
wherein the two or more optically active compounds have a complementary response to different wavelengths of the illuminating radiation.

2. The method of claim 1 wherein a laser or LED provides the illuminating radiation.

3. The method of claim 2 wherein a wavelength of the radiation produced by the laser or the LED varies with temperature.

4. The method of claim 1 wherein the complementary response of the two or more optically active compounds provides a constant optical response across a band of wavelengths.

5. The method of claim 1 where the width of 2 adjacent excitation bands is equal or greater than the difference in excitation wavelengths.
